(19) United States
(12) Patent Application Publication
(10) Pub. No.: US 2008/0004367 A1
(43) Pub. Date: Jan. 3, 2008

(54) CURABLE RESIN COMPOSITION

(75) Inventors: Motoyuki Takada, Kawasaki-shi (JP); Eiichi Hayashi, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: AJINOMOTO CO. INC., Tokyo (JP)

(21) Appl. No.: 11/755,410

(22) Filed: May 30, 2007

Related U.S. Application Data
(63) Continuation of application No. PCT/JP2005/022246, filed on Jun. 8, 2006.

(30) Foreign Application Priority Data
Nov. 30, 2004 (JP) 346792/2004
Nov. 30, 2004 (JP) 346793/2004

(51) Int. Cl. B32B 17/10

(52) U.S. Cl. 522/107

(57) ABSTRACT

The problem of the present invention is to provide a curable resin composition having a low dielectric tangent and affording a cured product superior in the adhesion strength to a conductor. According to the present invention, a curable resin composition comprising curable polyvinylbenzyl compound (A), and modified styrene elastomer (B) having one or more kinds of not less than one functional group selected from the group consisting of a hydroxyl group, a carboxyl group, an amino group and an acid anhydride group is provided. In this composition, dielectric powder (C) is easily dispersed, and a composition containing powder (C) can afford a cured product having a high dielectric constant. By curing the composition of the present invention, an insulating layer preferable for electrical circuits can be provided.

### TECHNICAL FIELD

The present invention relates to a curable resin composition useful as an insulating material for electronic components, particularly those used in the high frequency region. The present invention also relates to an adhesive film, an adhesive film with a copper foil and a prepreg, which are formed using the composition, as well as electronic components such as a printed circuit board having a layer obtained by curing the composition as an insulating layer and the like.

### BACKGROUND ART

In recent years, the information and telecommunications equipment has higher quality and function, and there is an increasing demand for downsized and high-density mounting electronic components used for information and telecommunications equipment. Under the circumstances, organic insulating materials and materials containing the organic insulating material and a dielectric powder are attracting attention.

For example, information and telecommunications equipment has a circuit board mounting a number of chip condensers to prevent malfunction and noise of electronic components such as digital IC and the like. To improve mounting density, a multi-layer printed circuit board having plural conductive layers and an insulating layer having high dielectric capacity, which is formed between the conductive layers, is known. The insulating layer in such a multi-layer printed circuit board plays a role of a condenser fitted in the circuit board.

On the other hand, to process massive amounts of data at a high speed, the frequency of the signals handled by information and telecommunications equipment tends to become higher. To suppress transmission loss of high frequency signals, the dielectric tangent of organic insulating materials used as dielectric materials is preferably set low, and moreover, variations in the relative dielectric constant and dielectric tangent are preferably small even when the temperature and humidity are high. As compounds useful therefor, for example, polyvinyl benzyl ether compound (JP-A-09-31006) and polyvinylbenzyl compound (WO02/083610, JP-A-2003-277440 and JP-A-2003-283076) are known.

Since a cured product having a low dielectric tangent, high heat resistance and low water absorption can be obtained from a composition containing such compound, the composition is useful as the aforementioned organic insulating material. However, the aforementioned cured product lacks high adhesion to a copper foil, though it is necessary for use in printed circuit boards and electronic components. In addition, the surface of the above-mentioned cured product resists formation of a plating metal layer having sufficient adhesive strength. When such a cured product is used, therefore, downsizing of electronic components by forming an ultrafine circuit having a conductive layer formed by plating is difficult.

Meanwhile, JP-A-2002-128977 discloses a curable polyvinyl benzyl ether resin composition containing a polyvinyl benzyl ether compound and a styrene elastomer. A cured product of the composition is reported to have the property of polyvinyl benzyl ether compound, as well as flexibility and high adhesion to a copper foil. However, the adhesion between the cured product and the copper foil is far from sufficient. In addition, formation of a conductive plating layer on the cured product is not considered at all, nor is considered addition of a dielectric powder to the above-mentioned composition.

Moreover, a polyvinylbenzyl compound superior to a polyvinyl benzyl ether compound in dielectric property is not considered at all as to how to improve adhesion to a copper foil and a conductive plating layer.

### SUMMARY OF THE INVENTION

It is therefore an object of the present invention to provide a curable resin composition affording a cured product layer having a low dielectric tangent and superior in the adhesive strength to a conductive layer, and moreover, an adhesive film, an adhesive film with a copper foil and a prepreg, which are formed using the composition, electronic components such as a printed circuit board using the adhesive film and the like, and production methods thereof.

The present inventors have conducted intensive studies in an attempt to solve the aforementioned problems and found that a curable resin composition comprising a particular curable compound and a particular elastomer can achieve the above-mentioned object, which resulted in the completion of the present invention. Furthermore, the present inventors have found that the composition can easily disperse a dielectric powder, and by dispersing the dielectric powder, the dielectric constant of the finally-obtained cured product can be controlled.

The present invention contains the following.

[1] A curable resin composition comprising curable polyvinylbenzyl compound (A), and modified styrene elastomer (B) having one or more kinds of not less than one functional group selected from the group consisting of a hydroxyl group, a carboxyl group, an amino group and an acid anhydride group.
[2] The curable resin composition of [1], wherein compound (A) is a compound represented by the following formula 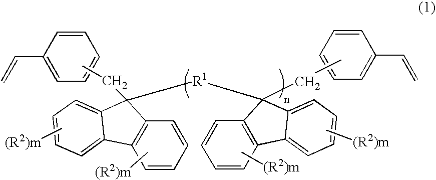
wherein
R¹ is a divalent organic group having 2 to 20 carbon atoms, each R² is the same or different and one group selected from the group consisting of a hydrogen atom, a halogen atom, an alkyl group, an alkoxy group and a thioalkoxy group, or two or more R² form a ring in combination, m is an integer of 0 to 4, and n is an integer of 0 to 20.
[3] The curable resin composition of [1] or [2], wherein elastomer (B) has one or more kinds of functional groups selected from the group consisting of a carboxyl group and an acid anhydride group.
[4] The curable resin composition of any one of [1] to [3], wherein the mass ratio of compound (A) to elastomer (B) is 50/50-97/3.
[5] The curable resin composition of any one of [1] to [4], further comprising dielectric powder (C).
[6] The curable resin composition of [5], wherein dielectric powder (C) is one or more kinds of powder selected from the group consisting of barium titanate, strontium titanate, calcium titanate, magnesium titanate, bismuth titanate, zirconium titanate, zinc titanate and titanium dioxide.
[7] The curable resin composition of [5] or [6], wherein dielectric powder (C) is surface-treated with a surface treating agent.
[8] The curable resin composition of [7], wherein the surface treating agent is one or more kinds of silane surface treating agents selected from the group consisting of styrylsilane, vinylsilane, acrylsilane and methacrylsilane.
[9] The curable resin composition of any one of [5] to [8], wherein the content of dielectric powder (C) in the curable resin composition is 50 to 95 mass %.
[10] An adhesive film comprising a supporting film and a layer made of the curable resin composition of any one of [1] to [9], which is formed on the aforementioned supporting film.
[11] An adhesive film with a copper foil, comprising a copper foil and a layer made of the curable resin composition of any one of [1] to [9], which is formed on the aforementioned copper foil.
[12] A prepreg obtained by impregnating a sheet fiber substrate with the curable resin composition of any one of [1] to [9].
[13] A method of producing a multi-layer printed circuit board, which comprises the following steps (1)-(7):
(1) a step of laminating the adhesive film of [10] on a circuit substrate,
(2) a step of removing or not removing the supporting film,
(3) a step of heat-curing the curable resin composition,
(4) a step of separating the supporting film when it is present,
(5) a step of roughening the surface of the cured product layer with an aqueous alkaline oxidant solution,
(6) a step of forming a conductive layer on the roughened surface of the cured product layer by plating, and
(7) a step of forming a circuit on the conductive layer.
[14] A method of producing a multi-layer printed circuit board, which comprises the following steps (1)-(6):
(1) a step of laminating the adhesive film with a copper foil of [11] on a circuit substrate,
(2) a step of heat-curing the curable resin composition,
(3) a step of removing the copper foil by dissolution,
(4) a step of roughening the surface of the cured product layer with an aqueous alkaline oxidant solution,
(5) a step of forming a conductive layer on the roughened surface of the cured product layer by plating, and
(6) a step of forming a circuit on the conductive layer.
[15] A method of producing a multi-layer printed circuit board, which comprises the following steps (1)-(3):
(1) a step of laminating the adhesive film with a copper foil of [11] on a circuit substrate,
(2) a step of heat-curing the curable resin composition, and
(3) a step of forming a circuit on the copper foil layer.
[16] A method of producing a multi-layer printed circuit board, which comprises the following steps (1)-(5):
(1) a step of laminating the prepreg of [12] on a circuit substrate,
(2) a step of heat-curing the curable resin composition,
(3) a step of roughening the surface of the cured product layer with an aqueous alkaline oxidant solution,
(4) a step of forming a conductive layer on the roughened surface of the cured product layer by plating, and
(5) a step of forming a circuit on the conductive layer.
[17] A multi-layer printed circuit board comprising an insulating layer and a conductive layer, wherein at least a part of the aforementioned insulating layer is formed by curing the curable resin composition of any one of [1]-[9].
[18] An electronic component comprising an insulating layer, wherein at least a part of the aforementioned insulating layer is formed by curing the curable resin composition of any one of [1]-[9].
[19] A multi-layer printed circuit board comprising an insulating layer and a conductive layer, wherein at least a part of the aforementioned insulating layer is formed by curing the prepreg of [12].
[20] An electronic component comprising an insulating layer, wherein at least a part of the aforementioned insulating layer is formed by curing the prepreg of [12].

The curable resin composition of the present invention (hereinafter to be also referred to as the composition of the present invention) have properties derived from the curable polyvinylbenzyl compound, such as low dielectric tangent, high heat resistance, low water absorption, and small variation in the dielectric property caused by temperature and moisture absorption. Furthermore, the cured product layer obtained from the composition closely adheres to a copper foil and a conductive plating layer. Using the curable resin composition of the present invention, therefore, printed circuit boards and electronic components can be provided. In addition, the composition of the present invention can be processed into the form of an adhesive film and, using the adhesive film, electronic components such as printed circuit board and the like can be produced more efficiently.

### BEST MODE FOR EMBODYING THE INVENTION

In the present invention, the curable resin composition is a composition before curing and containing a resin. In other words, the composition has not been cured and can be cured mostly with heat.

In the present invention, the curable polyvinylbenzyl compound (hereinafter to be also referred to as compound (A)) has two or more vinylbenzyl groups in a molecule, and is an uncured compound that can be cured mostly with heat. Compound (A) can be produced, for example, by various methods including 1) reacting an indene compound with a vinylbenzyl halide in the presence of an alkali, 2) reacting an indene compound with a vinylbenzyl halide and a dihalomethyl compound having 2 to 20 carbon atoms in the presence of an alkali, 3) reacting an indene compound with a fluorene compound, a vinylbenzyl halide and a dihalomethyl compound having 2 to 20 carbon atoms in the presence of an alkali (JP-A-2003-277440), or 4) reacting an indene compound with a fluorene compound and a vinylbenzyl halide in the presence of an alkali (WO02/083610) and the like. To lower the dielectric tangent, it is preferable that the curable polyvinylbenzyl compound does not contain a hetero atom in a molecule.

As the indene compound, a compound represented by the following formula (2) can be mentioned.

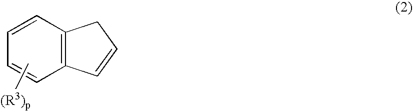

wherein

each R³ is the same or different and one group selected from the group consisting of a hydrogen atom, a halogen atom, an alkyl group (preferably an alkyl group having 1 to 5 carbon atoms), an alkoxy group (preferably an alkoxy group having 1 to 5 carbon atoms) and a thioalkoxy group (preferably a thioalkoxy group having 1 to 5 carbon atoms), or two or more R³ form a ring in combination, and p is an integer of 0 to 4. As the ring formed by two or more R³ in combination, a structure wherein an indene ring is condensed with a ring such as a 5- to 8-membered cycloalkyl ring, a benzene ring and the like can be mentioned.

As the fluorene compound, a compound represented by the following formula (3) can be mentioned.

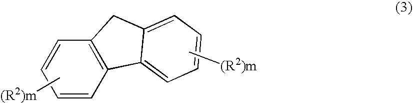

wherein

each R² is the same or different and one group selected from the group consisting of a hydrogen atom, a halogen atom, an alkyl group (preferably an alkyl group having 1 to 5 carbon atoms), an alkoxy group (preferably an alkoxy group having 1 to 5 carbon atoms) and a thioalkoxy group (preferably a thioalkoxy group having 1 to 5 carbon atoms), or, two or more R² form a ring in combination, and m is an integer of 0 to 4. As the ring formed by two or more R² in combination, a structure wherein a fluorene ring is condensed with a ring such as a 5- to 8-membered cycloalkyl ring, a benzene ring and the like can be mentioned.

As the vinylbenzyl halide, those described in the above-mentioned prior art references and the like can be used appropriately. As the dihalomethyl compound having 2 to 20 carbon atoms, for example, alkylene dihalides such as 1,2-dichloroethane, 1,2-dibromoethane, 1,3-dichloropropane, 1,3-dibromopropane, 1,4-dichlorobutane, 1,4-dibromobutane and the like; dihalomethyl compounds such as o-xylylene dichloride, o-xylylene dibromide, m-xylylene dichloride, m-xylylene dibromide, p-xylylene dichloride, p-xylylene dibromide, 4,4′-bis(chloromethyl)biphenyl, 4,4′-bis(chloromethyl)diphenyl ether, 4,4′-bis(chloromethyl)diphenylsulfide, 2,6-bis(bromomethyl)naphthalene, 1,8-bis(bromomethyl)naphthalene, 1,4-bis(chloromethyl)naphthalene and the like can be mentioned.

As the alkali in the reaction of the above-mentioned 1)-3), for example, sodium methoxide, sodium ethoxide, sodium hydride, potassium hydride, sodium hydroxide, potassium hydroxide and the like can be mentioned.

Such curable polyvinylbenzyl compounds can be produced easily according to the descriptions of JP-A-2003-277440, WO 02/083610 and the like.

As preferable curable polyvinylbenzyl compound, a compound represented by the following formula (1) can be mentioned.

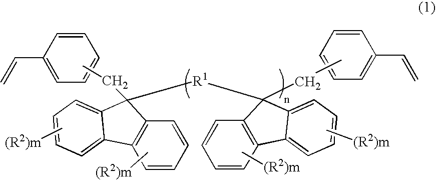

wherein

R¹ is a divalent organic group having 2 to 20 carbon atoms, each R² is the same or different and one group selected from the group consisting of a hydrogen atom, a halogen atom, an alkyl group (preferably an alkyl group having 1 to 5 carbon atoms), an alkoxy group (preferably an alkoxy group having 1 to 5 carbon atoms) and a thioalkoxy group (preferably a thioalkoxy group having 1 to 5 carbon atoms) or two or more R² form a ring in combination, m is an integer of 0 to 4, and n is an integer of 0 to 20. As the ring formed by two or more R² in combination, a structure wherein a fluorene ring is condensed with a ring such as a 5- to 8-membered cycloalkyl ring, a benzene ring and the like can be mentioned.

As particularly preferable curable polyvinylbenzyl compound, a compound represented by the following formula (4) can be mentioned.

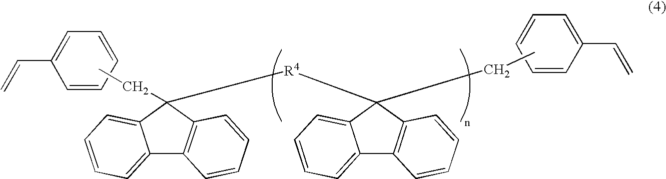

In the formula (4), R⁴ is a divalent organic group having 2 to 20 carbon atoms (preferably an alkyl group), and n is an integer of 0 to 20.

As commercially available curable polyvinylbenzyl compound, polyvinyl benzyl resins manufactured by SHOWA HIGHPOLYMER CO., LTD.: V-5000X (Tg of cured product layer 154° C., relative dielectric constant 2.63, dielectric tangent 0.0016), V-6000X (Tg of cured product layer 136° C., relative dielectric constant 2.59, dielectric tangent 0.0013) and the like can be mentioned.

In the present invention, two or more different kinds of polyvinylbenzyl compounds can be used concurrently.

In the present invention, the “modified styrene elastomer having one or more kinds of not less than one functional group selected from the group consisting of a hydroxyl group, a carboxyl group, an amino group and an acid anhydride group” (hereinafter to be also referred to as elastomer (B)) has a chemical structure containing at least one of the functional groups recited above on the molecular chain of a copolymer of a thermoplastic elastomer such as butadiene, isoprene, ethylene, butylene, propylene and the like and styrene.

Elastomer (B) can be produced, for example, by 1) a method including an addition reaction of a living terminal of a styrene elastomer with a modifying agent having one or more functional groups recited above, using an organic lithium compound as a polymerization catalyst, 2) a method including a reaction of a styrene elastomer free of a living terminal with an organic alkali metal compound such as an organic lithium compound and the like, which is followed by an addition reaction of the styrene elastomer added with the organic alkali metal with a modifying agent having the functional group recited above, and the like (JP-A-2004-59741). In the method of the above-mentioned 1), only a part of the living terminal of the elastomer needs to be modified and modification of all living terminals is not necessary. As the modifying agent, for example, the terminal modifying treatment agents described in JP-B-4-39495 and the like can be used.

Elastomer (B) may be converted to a hydrogenated modified styrene elastomer by hydrogenation. The method of hydrogenation is not particularly limited and, for example, a method including introducing a hydrogen gas for pressurization to a given pressure in the presence of a hydrogenation catalyst such as a titanocene compound, a reductive organometallic compound and the like, as described in JP-B-1-37970, JP-B-1-53851 and the like, can be mentioned. When a styrene elastomer has a living terminal, hydrogenation reaction may be performed after an addition reaction of a modifying agent and, when a living terminal is absent, hydrogenation reaction may be performed before or after the addition reaction of a modifying agent.

The production method of the non-modified styrene elastomer is not particularly limited and, for example, the elastomer can be produced by copolymerizing a vinyl aromatic compound such as styrene and the like and a conjugated diene such as butadiene and the like in a reaction tank with a stirring device. For copolymerization, an aliphatic hydrocarbon alkali metal compound having an anionic polymerization activity, such as n-butyllithium and the like, is preferably used. Copolymerization may be any of a batch polymerization, a continuous polymerization, and a combination of them.

As the styrene elastomer, for example, styrene-butadiene-styrene block copolymer (SBS), styrene-isoprene-styrene block copolymer (SIS), styrene-ethylene-butylene-styrene block copolymer (SEBS), styrene-ethylene-propylene-styrene block copolymer (SEPS), styrene-ethylene-ethylene-propylene-styrene block copolymer (SEEPS), styrene-butadiene-butylene-styrene block copolymer (SBBS) and the like can be mentioned. Of these, one wherein an intramolecular unsaturated double bond other than aromatic ring is hydrogenated, like the styrene-ethylene-butylene-styrene block copolymer (SEBS), is preferable for avoiding degradation of the dielectric property due to oxidation. As commercially available non-modified styrene elastomer, “Septon S8104” (SEBS manufactured by KURARAY CO., LTD.), “TUFTEC H1043” (SEBS manufactured by ASAHI KASEI CHEMICALS CORPORATION) and the like can be mentioned.

The weight average molecular weight of elastomer (B) is preferably 10,000 to 1,000,000. When the weight average molecular weight is less than 10,000, the heat resistance tends to decrease, and the adhesive strength between a copper foil and a conductive plating layer and an insulating layer tends to decrease. When the weight average molecular weight is greater than 1,000,000, dissolution in a solvent tends to become difficult and the compatibility with a vinylbenzyl resin tends to be degraded.

In the present invention, the weight average molecular weight is measured by a gel permeation chromatography (GPC) method (based on polystyrene). Specifically, the GPC method includes, for example, measurement using LC-9A/RID-6A manufactured by Shimadzu Corporation as a measurement apparatus, Shodex K-800P/K-804L/K-804L manufactured by SHOWA DENKO K.K. as a column, chloroform as a mobile phase, a column temperature of 40° C., and the analytical curve of standard polystyrene.

The content rate of styrene in elastomer (B) is preferably 20-80 mass %, more preferably 30-70 mass %. When the styrene content rate is too low, the compatibility between elastomer (B) and vinylbenzyl resin tends to be degraded and when the content rate is too high, the adhesive strength between a copper foil or a conductive plating layer and an insulating layer tends to decrease. To control the styrene content rate, the reaction rate of a vinyl aromatic compound such as styrene and the like and conjugated diene such as butadiene and the like can be controlled. The styrene content rate can be measured, for example, by determining the absorbance of the styrene moiety in a modified styrene elastomer solution at a given concentration using an ultraviolet spectrophotometer.

As elastomer (B), a commercially available product can be used. Commercially available modified styrene elastomer includes, for example, “Septon HG252” (manufactured by KURARAY CO., LTD.) which is a modified styrene elastomer (modified SEEPS) having a hydroxyl group, “TUFTEC N503M” which is a modified styrene elastomer (modified SBBS) having a carboxyl group, “TUFTEC N501” which is a modified styrene elastomer (modified SBBS) having an amino group, “TUFTEC M1913” which is a modified styrene elastomer (modified SEBS) having an acid anhydride group (each manufactured by ASAHI KASEI CHEMICALS CORPORATION) and the like.

In the present invention, two or more kinds of different modified styrene elastomers may be used concurrently.

According to the present invention, the mass ratio of compound (A) to elastomer (B) in a curable resin composition, i.e., (A/B), is preferably 50/50-97/3, more preferably 70/30-90/10. When the ratio of compound (A) is too high, the adhesion between a copper foil or a conductive plating layer and an insulating layer tends to be degraded and, when it is too low, the property derived from the curable polyvinylbenzyl compound, such as dielectric property and the like cannot be sufficiently exhibited.

The composition of the present invention permits easy dispersion of a dielectric powder. By controlling the kind and amount of the dielectric powder, the dielectric constant of a cured product obtained from the composition of the present invention can be controlled.

As dielectric powder (C) that the composition of the present invention may contain, a powder of an inorganic material generally used as a dielectric material can be used appropriately. Specific examples include barium titanate, strontium titanate, calcium titanate, magnesium titanate, bismuth titanate, zirconium titanate, zinc titanate, titanium dioxide and the like. The relative dielectric constant of dielectric powder (C) is preferably 100-20000, more preferably 1000-20000. The average particle size of dielectric powder (C) is preferably 0.2-100 μm, more preferably 0.2-10 μm. When the average particle size is too small, dispersion of the dielectric powder in a resin composition tends to become difficult and, when the average particle size is too large, dispersion tends to be nonuniform.

The average particle size of the dielectric powder can be measured by a laser diffraction•scattering method based on the Mie scattering theory. To be specific, using a laser diffraction particle size distribution measurement apparatus, the particle size distribution of the dielectric powder is determined based on volume and the median diameter thereof can be taken as the average particle size. As a measurement sample, a dielectric powder dispersed in water by ultrasonication can be preferably used. As the laser diffraction particle size distribution measurement apparatus, LA-500 manufactured by Horiba, Ltd. and the like can be used.

The particle shape of the dielectric powder is not particularly limited, and may be a disrupted amorphous shape, preferably a sphere. The spherical dielectric powder can be contained more in a resin composition, which in turn increases the dielectric capacity.

In consideration of more uniform dispersion in a resin composition, dielectric powder (C) is preferably surface-treated with a surface treating agent. As the surface treating agent, a silane surface treating agent is preferable. As the silane surface treating agent, a silane surface treating agent having a double bond in a molecule is preferable, and the treating agent includes, for example, styrylsilane, vinylsilane, acrylsilane, methacrylsilane and the like. The silane surface treating agent is particularly preferably acrylsilane or styrylsilane, more preferably acrylsilane, which is more economical. Commercially available treating agents include KBM5103 (manufactured by Shin-Etsu Chemical Co., Ltd.: acrylsilane), KBM1403 (manufactured by Shin-Etsu Chemical Co., Ltd.: styrylsilane) and the like.

In the present invention, two or more kinds of different dielectric powders may be used concurrently.

When the composition of the present invention contains dielectric powder (C), the content of powder (C) in the composition is preferably 50-95 mass %, more preferably 60-80 mass %. When the composition contains dielectric powder (C) in an amount exceeding 95 mass %, uniform dispersion of dielectric powder (C) becomes difficult, and the film formation tends to be difficult. On the other hand, when the content of dielectric powder (C) is less than 50 mass %, sufficient property as a high dielectric material tends to be unavailable.

The composition of the present invention may contain other polymerizable compounds where necessary. As polymerizable compounds, for example, styrene, divinylbenzene, allyl ester, acrylate, methacrylate and the like can be mentioned. Where necessary, other resins such as thermosetting resin and the like, for example, epoxy resin, brominated epoxy resin, maleimide resin, cyanate resin and the like can be contained. The curable polyvinylbenzyl compound of the present invention can be cured by heat even in the absence of a curing catalyst. When the above-mentioned other polymerizable compound, other resin and the like are to be added, a curing catalyst suitable for them may be added as appropriate. For example, when allyl ester and the like are added, a radical polymerization initiator having a comparatively long half-life, such as dicumyl peroxide, 1,1-bis(t-butylperoxy)3,3,5-trimethylcyclohexane and the like, is preferably added as a curing catalyst. The amount of the curing catalyst to be used is generally within the range of 0.1-10 parts by mass relative to a total of 100 parts by mass of compound (A) and a copolymerizable compound. When the curable resin composition does not contain dielectric powder (C), the composition preferably contains components other than compound (A) and elastomer (B) in a proportion of not more than 30 parts by mass relative to a total of 100 parts by mass of compound (A) and elastomer (B), or does not contain such components at all. When the curable resin composition contains dielectric powder (C), the composition preferably contains components other than compound (A), elastomer (B) and dielectric powder (C) in a proportion of not more than 30 parts by mass relative to a total of 100 parts by mass of compound (A), elastomer (B) and dielectric powder (C), or does not contain such components at all.

To obtain a cured product having high mechanical strength and high flame-retardancy, the composition of the present invention may further contain an organic filler and an inorganic filler. As the organic filler, acrylic rubber fine particles having a core shell structure, a silicon powder, a nylon powder and the like can be mentioned and, as the inorganic filler, silica, alumina, magnesium hydroxide, aluminum hydroxide, zinc borate, antimony oxide and the like can be mentioned. Particularly, an inorganic filler such as silica and the like can be contained for the purpose of decreasing the coefficient of thermal expansion of the composition of the present invention. When the composition of the present invention contains an inorganic filler, the inorganic filler is contained within the range of preferably 30-70 mass %, more preferably 40-60 mass %, in the composition. The average particle size of the inorganic filler is preferably not more than 5 μm, more preferably 0.01-5 μm. These inorganic fillers may be surface-treated with a surface treating agent such as a silane surface treating agent and the like, as in the above.

The composition of the present invention can be preferably used as a material for electronic components mainly represented by circuit substrate. The composition of the present invention is preferably used after processing into an adhesive film. To be specific, a curable resin composition is dissolved in an organic solvent to give a varnish, the varnish is applied to a supporting film or copper foil, and the organic solvent is evaporated by heating, blowing hot air and the like, whereby an adhesive, curable resin composition layer can be formed. By forming such adhesive film, producibility of electronic components such as multi-layer printed circuit board and the like can be improved and the insulating layer can be easily made thin. Accordingly, the composition of the present invention is preferable for the production of electronic components requesting downsizing, such as printed circuit board and the like. Preferably, a multi-layer printed circuit board with a built-in high dielectric capacity condenser can be easily produced.

The drying conditions for producing an adhesive film are not particularly limited, and drying is performed to achieve the content of the organic solvent in the resin composition layer of generally not more than 5 wt %, preferably not more than 3 wt %. For example, when a varnish containing 30-60 wt % of an organic solvent is used, the resin composition layer is dried at 50° C.-150° C. for about 3-10 min. By a simple experiment, preferable drying conditions can be easily determined as appropriate. The resin composition layer of the adhesive film is generally made thicker than the conductive layer of the circuit substrate to be produced. Since the thickness of the conductive layer of a circuit substrate is generally within the range of 5-70 μm, the thickness of the resin composition layer is preferably 10-100 μm.

The organic solvent to be used for the preparation of the resin varnish is not particularly limited and ketones such as methylethylketone, methylisobutylketone, cyclohexanone and the like, acetate esters such as ethyl acetate, butyl acetate, cellosolve acetate, propylene glycol monomethyl ether acetate, Carbitol acetate and the like, cellosolves such as cellosolve, butylcellosolve and the like, Carbitols such as Carbitol, butylcarbitol and the like, aromatic hydrocarbons such as toluene, xylene, solvent naphtha and the like, amides such as N,N-dimethylformamide, N,N-dimethylacetamide, N-methylpyrrolidone and the like can be mentioned. Two or more kinds of the organic solvents can also be used in combination.

In the present invention, the supporting film of the adhesive film is an organic resin film. As the organic resin, polyolefins such as polyethylene, polypropylene and the like, polyesters such as polyethylene terephthalate, polyethylene naphthalate and the like, and the like can be mentioned. Particularly, polyethylene terephthalate is preferable. The surface of the supporting film may be applied to a mud treatment, a corona treatment or a release treatment. The thickness of the supporting film is not particularly limited, and is generally 10-150 μm, preferably 25-50 μm. The curable resin composition layer may be protected with a protection film. By protecting with a protection film, attachment of dirt and the like to the resin composition layer surface and scratches thereon can be prevented. The protection film may be made from the same material as the material of the above-mentioned supporting film, and the thickness is preferably 1-40 μm.

According to the present invention, a curable resin composition layer may be formed on a copper foil to produce an adhesive film. As the copper foil, an electrolytic copper foil, a rolled copper foil and the like, as well as an ultrathin copper foil with a carrier, a foil wherein a copper vapor deposition layer is formed on a release-treated, peel-off film made from polyethylene terephthalate and the like can be mentioned.

The thickness of the copper foil is preferably 9-35 μm. In the case of an ultrathin copper foil with a carrier, the thickness of the copper foil is preferably 1-5 μm. When a copper vapor deposition layer is formed on a peel-off film, the thickness of the copper vapor deposition layer is generally 100 Å-5000 Å.

To increase adhesion strength by anchor effect, the surface of the copper foil, on which a curable resin composition layer is to be formed, is preferably subjected to a roughening treatment. The method of roughening treatment is not particularly limited, and a known method can be employed. For example, a roughening method including etching, a method including immersing a copper foil in an aqueous copper sulfate solution and precipitating copper by electrolysis to form ultrafine copper particles on a copper foil surface and the like can be mentioned. After the roughening treatment of the surface, a rust preventing treatment or a treatment for improving adhesiveness to a resin, such as a chromate treatment, a black oxide treatment and the like, may be applied. For suppression of the transmission loss, the surface roughness (Rz) of the copper foil is preferably not more than 6.0 μm, more preferably not more than 4.0 μm, still more preferably not more than 3.0 μm. The surface roughness can be defined by the Ten-Point Height of Irregularities (Rz) of JIS B 0601-1994 “Definition and Indication of Surface Roughness”.

As commercially available copper foil, JTC-LP foil and JTC-AM foil (both manufactured by NIKKO MATERIALS CO., LTD.), GTS-MP foil and F2-WS foil (both manufactured by FURUKAWA CIRCUIT FOIL CO., LTD.) and the like can be mentioned.

According to a preferable embodiment of the present invention, in consideration of the formation of an ultrafine circuit on the surface of the cured product layer, the composition of the present invention is formed into an adhesive film with a copper foil, then the copper foil is removed by etching, and a conductive layer is formed on the surface of the cured product layer by plating. In this case, preferably, an adhesive film with a copper foil is laminated on a circuit substrate, the curable resin composition is heat-cured, the copper foil layer is removed by dissolution, and the surface of the cured product layer exposed by removal of the copper foil layer is roughened with an aqueous alkaline oxidant solution. While the surface of the cured product layer exposed by removal of the copper foil layer is rough to a certain degree, when a more closely-adhered conductive plating layer is to be obtained, the surface of the cured product layer is preferably subjected to a further roughening treatment with an alkaline oxidant solution. According to the present invention, the copper foil layer itself of the adhesive film with a copper foil may be patterned to directly form a circuit, without dissolving-removing the copper foil layer. However, an ultrafine circuit can be easily formed by forming a circuit on a conductive plating layer, rather than forming a circuit on an electrolytic copper foil or a rolled copper foil itself. Ultrathin copper foil and copper vapor deposition film are high in the cost.

Each adhesive film laminated in the order of protection film/curable resin composition layer/supporting film or protection film/curable resin composition layer/copper foil, wherein the curable resin composition layer is protected with a protection film, can be wound in a roll and stored.

As another mode of use of the curable resin composition of the present invention, a prepreg can be mentioned. Prepreg can be obtained by preparing a varnish containing the composition of the present invention as mentioned above, impregnating a sheet fiber substrate such as cloth, non-woven fabric and the like with the varnish by a hot melt method, a solvent method and the like, and drying the substrate. The hot melt method is a method for producing a prepreg by once coating a release paper permitting easy release of a resin with the resin, without dissolving the resin in an organic solvent, then laminating the release paper on a sheet fiber substrate, or directly applying the resin using a die coater and the like. The solvent method is a method including, in the same manner as for the adhesive film, preparing a resin varnish by dissolving a resin in an organic solvent, immersing a sheet fiber substrate in the varnish to allow impregnation of the sheet fiber substrate with the resin varnish, and thereafter drying the substrate.

As the sheet fiber substrate to be used for obtaining a prepreg in the present invention, cloth, non-woven fabric and the like can be mentioned. As the cloth, glass cloth, carbon fiber cloth, stretched porous polytetrafluoroethylene and the like can be mentioned. As the non-woven fabric, aramid non-woven fabric, glass paper, liquid crystal polymer non-woven fabric and the like can be mentioned.

Now, a method of producing a multi-layer printed circuit board of the present invention, which uses an adhesive film with a copper foil, is explained. When the resin composition layer is protected with a protection film, the protection film is released, and an adhesive film is laminated on one surface or both surfaces of a circuit substrate so that the resin composition layer will contact the circuit substrate. Lamination is preferably performed under reduced pressure using a vacuum laminator. The lamination method may be a batch method or a continuous method using a roll. The adhesive film and circuit substrate may be heated, where necessary, before lamination. The press temperature is preferably set to 70-140° C., the press pressure is preferably set to 1-11 kgf/cm² (9.8×10⁴−107.9×10⁴ N/m²), and lamination is preferably performed under reduced pressure (air pressure in the vacuum laminator is 20 mmHg (26.7 hPa) or below).

The vacuum lamination can be performed using a commercially available vacuum laminator. As the commercially available vacuum laminator, for example, a vacuum applicator manufactured by NICHIGO-MORTON CO., LTD., a vacuum pressurization laminator manufactured by MEIKI CO., LTD., a roll dry coater manufactured by HITACHI INDUSTRIES CO., LTD., a vacuum laminator manufactured by HITACHI AIC INC. and the like can be mentioned.

The circuit substrate to be used in the present invention is not particularly limited, and mainly a substrate itself, such as glass epoxy, metal substrate, polyester substrate, polyimide substrate, BT resin substrate, thermosetting polyphenylene ether substrate and the like, or these substrates with a circuit formed on one surface or both surfaces of the substrates. In addition, a multi-layer printed circuit board wherein a conductive layer (circuit) and an insulating layer are alternately formed, and a circuit is formed on one surface or both surfaces of the outermost layer is also encompassed in the circuit substrate in the context of the present invention. The surface of the conductor circuit layer is preferably subjected to a roughening treatment in advance such as a black oxide treatment and the like, from the aspect of adhesion of the insulating layer to a circuit substrate.

The resin composition layer of an adhesive film with a copper foil laminated on a circuit substrate as mentioned above is cured by heat curing. The conditions for heat curing are selected from the range of preferably 150° C.-220° C. for 20 min—180 min, more preferably 160° C.-200° C. for 30-120 min. Then, the copper foil is removed by dissolution with an etching solution. As the etching solution, a ferric chloride solution, a copper chloride solution and the like can be mentioned. When the copper foil is removed, the surface of the cured product layer derived from the resin composition of the present invention appears. The surface is rough to a certain degree.

Then, an insulating layer (cured product layer) laminated on the circuit substrate is perforated as necessary to form a via hole and a through hole. The hole may be made, for example, by a known method such as drill, laser, plasma and the like, or these methods in combination. More conventionally, a method using a laser such as a carbon dioxide gas laser, a YAG laser and the like can be employed.

Then, the surface of the insulating layer is subjected to a roughening treatment using an aqueous alkaline oxidant solution. When a hole has been made in the insulating layer, the roughening step also becomes a desmear step for the inside of the hole. As the aqueous alkaline oxidant solution, an aqueous solution of potassium permanganate, sodium permanganate and the like can be used. In this way, by removing the copper foil by dissolving it with an etching solution and treating the surface of the cured product layer exposed by removing the copper foil with an aqueous alkaline oxidant solution, the surface of the cured product layer becomes rough to the extent preferable for forming a conductive plating layer, and a conductive plating layer having a high adhesive strength can be formed.

It is possible to form a conductive layer on the surface of the cured product layer by, for example, a method combining electroless plating and electroplating. As the conductive layer, a copper plating layer can be mentioned. It is also possible to form a plating resist having a reverse pattern to that of the conductive layer and form a conductive layer by electroless plating alone. An anneal treatment may be applied, for example, at 150-200° C. for about 20-90 min after forming a conductive layer. As a method for patterning a conductive layer into a circuit, for example, subtractive method, semiadditive method and the like known to those of ordinary skill in the art can be mentioned.

Since a thin conductive layer can be obtained, formation of a conductive layer by plating is suitable for forming an ultrafine circuit. If the requirement for the circuit pitch can be fulfilled, a circuit can also be formed by patterning a copper foil layer itself by subtractive method and the like as mentioned above.

Now, a method of producing the multi-layer printed circuit board of the present invention using an adhesive film is explained. The method, conditions and the like for laminating an adhesive film on a circuit substrate are the same as those when using an adhesive film with a copper foil. An insulating layer (cured product layer) can be formed on a circuit substrate by heat-curing the curable resin composition after laminating an adhesive film on the circuit substrate. The conditions for heat-curing are as mentioned above. The supporting film may be released before or after the heat-curing. Then, a hole is formed as necessary in the insulating layer (cured product layer) laminated on the circuit substrate to give a via hole or a through hole. The method and conditions for forming a hole are the same as those mentioned above. Then, the surface of the insulating layer is roughened with an aqueous alkaline oxidant solution. The method and conditions for roughening are also the same as those mentioned above. A conductive layer is formed on the roughened surface of the cured product layer by a method combining electroless plating and electroplating. It is also possible to form a plating resist having a reverse pattern to that of the conductive layer and form a conductive layer by electroless plating alone. After forming a conductive layer, an anneal treatment may be applied, for example, at 150-200° C. for about 20-90 min. As a method for patterning a conductive layer into a circuit, for example, subtractive method, semiadditive method and the like known to those of ordinary skill in the art can be used.

A method of producing the multi-layer printed circuit board of the present invention using the prepreg of the present invention is now explained. One or, where necessary, several prepregs of the present invention are layered on a circuit substrate, a metal plate is sandwiched via a release film and the laminate is pressed under pressurization•heating conditions. The pressure is preferably 5-50 kgf/cm², the temperature is preferably 100-200° C. and molding for 20-100 min is preferable. It is also possible to laminate a prepreg on a circuit substrate by the vacuum lamination method, and then heat-cure the prepreg. Thereafter, as mentioned above, the surface of the cured prepreg is roughened with an aqueous alkaline oxidant solution, a conductive plating layer is formed, and the conductive layer is patterned to give a multi-layer printed circuit board.

The curable resin composition of the present invention can be preferably used as an insulating material for a multi-layer printed circuit board with a built-in condenser, as well as various electronic components such as transmitter, resonator, capacitor, antenna, power amplifier, filter, RF module, inductor and the like.

For use in the above-mentioned electronic components, the cured product layer of the curable resin composition of the present invention preferably maintains a variation rate of relative dielectric constant of within 2.0% and a dielectric tangent value of not more than 0.007 at measurement frequency 5 GHz and temperature 23° C., after standing at 125° C. for 1000 hr, and at 85° C., humidity 85% for 1000 hr. The variation value of relative dielectric constant can be represented by the following formula:
variation value=100(%)×(relative dielectric constant after standing−relative dielectric constant before standing)/relative dielectric constant before standing

### EXAMPLES

The present invention is explained in detail in the following by referring to Examples, which are not to be construed as limitative.

### Example 1

Modified styrene elastomer having an acid anhydride group (modified SEBS) (6 parts by mass, M1913 manufactured by ASAHI KASEI CHEMICALS CORPORATION, styrene content 30%), a strontium titanate powder subjected to a styrylsilane treatment (70 parts by mass) and toluene (18 parts by mass) were added to a toluene varnish of a polyvinylbenzyl compound (37 parts by mass, V5000X manufactured by SHOWA HIGHPOLYMER CO., LTD., nonvolatile content 65%) [resin component 24 parts by mass], and the mixture was stirred to complete dispersion to give a varnish containing a curable resin composition. This varnish was applied to a polyethylene terephthalate (hereinafter to be abbreviated as PET) film of 38 μm thickness, and dried at 70-120° C. for 12 min to give an adhesive film having a curable resin composition layer of 50 μm thickness. Separately, the above-mentioned varnish was applied to an electrolytic copper foil (F2-WS foil, thickness 18 μm, Rz of treated surface=2.3 μm) manufactured by FURUKAWA CIRCUIT FOIL CO., LTD., dried at 70-120° C. for 12 min to give an adhesive film with a copper foil having a curable resin composition layer of 50 μm thickness.

### Example 2

Modified styrene elastomer having an acid anhydride group (modified SEBS) (5.5 parts by mass, M1913 manufactured by ASAHI KASEI CHEMICALS CORPORATION, styrene content 30%), a strontium titanate powder subjected to a styrylsilane treatment (70 parts by mass) and toluene (18 parts by mass) were added to a toluene varnish of a polyvinylbenzyl compound (33.5 parts by mass, V5000X manufactured by SHOWA HIGHPOLYMER CO., LTD., nonvolatile content 65%) [resin component 21.8 parts by mass], then a trifunctional acrylate monomer (2.7 parts by mass, KAYARAD R790 manufactured by NIPPON KAYAKU CO., LTD.) having an isocyanurate skeleton copolymerizable with a polyvinylbenzyl compound was added, and the mixture was stirred to complete dispersion to give a varnish containing a curable resin composition. This varnish was applied to a PET film of 38 μm thickness, and dried at 70-120° C. for 12 min to give an adhesive film having a curable resin composition layer of 50 μm thickness. Separately, the above-mentioned varnish was applied to an electrolytic copper foil (F2-WS foil, thickness 18 μm, Rz of treated surface=2.3 μm) manufactured by FURUKAWA CIRCUIT FOIL CO., LTD., dried at 70-120° C. for 12 min to give an adhesive film with a copper foil having a curable resin composition layer of 50 μm thickness.

### Example 3

In the same manner as in Example 1 except that a modified styrene elastomer having a carboxyl group (modified SBBS) (N503M manufactured by ASAHI KASEI CHEMICALS CORPORATION, styrene content 30%) was used instead of the modified styrene elastomer having an acid anhydride group (modified SEBS) (M1913 manufactured by ASAHI KASEI CHEMICALS CORPORATION) and a strontium titanate powder subjected to an acrylsilane treatment was used instead of the strontium titanate powder subjected to the styrylsilane treatment, an adhesive film and an adhesive film with a copper foil were obtained.

### Comparative Example 1

A styrene-butadiene-styrene block copolymer (6 parts by mass, S8104, manufactured by KURARAY CO., LTD., styrene content 60%) hydrogenated at the unsaturated double bond moiety, a strontium titanate powder subjected to an acrylsilane treatment (70 parts by mass) and toluene (18 parts by mass) were added to a toluene varnish of a polyvinyl benzyl ether compound (40 parts by mass, V1100X manufactured by SHOWA HIGHPOLYMER CO., LTD., nonvolatile content 60%) [resin component 24 parts by mass] and the mixture was stirred to complete dispersion to give a varnish containing a curable resin composition. This varnish was applied to a polyethylene terephthalate film of 38 μm thickness, and dried at 70-120° C. for 12 min to give an adhesive film having a curable resin composition layer of 50 μm thickness. Separately, the above-mentioned varnish was applied to an electrolytic copper foil (F2-WS foil, thickness 18 μm, Rz of treated surface=2.3 μm) manufactured by FURUKAWA CIRCUIT FOIL CO., LTD., dried at 70-120° C. for 12 min to give an adhesive film with a copper foil having a curable resin composition layer of 50 μm thickness.

### Example 4

In the same manner as in Example 1 except that the strontium titanate powder was not added, a varnish containing a curable resin composition, an adhesive film and an adhesive film with a copper foil were obtained.

### Example 5

In the same manner as in Example 2 except that the strontium titanate powder was not added, a varnish containing a curable resin composition, an adhesive film and an adhesive film with a copper foil were obtained.

### Example 6

In the same manner as in Example 3 except that the strontium titanate powder was not added, a varnish containing a curable resin composition, an adhesive film and an adhesive film with a copper foil were obtained.

### Comparative Example 2

In the same manner as in Comparative Example 1 except that the strontium titanate powder was not added, a varnish containing a curable resin composition, an adhesive film and an adhesive film with a copper foil were obtained.

[Measurement of Relative Dielectric Constant (∈r) and Dielectric Tangent (tan δ)]

Curable resin composition layers of two adhesive films were faced with each other and laminated with a vacuum laminator under the conditions of temperature 80° C., pressure 1 kgf/cm² (9.8×10⁴ Pa), air pressure not more than 5 mmHg (6.7×10² Pa). After lamination, one PET film was peeled off to expose the curable resin composition layer, and a curable resin composition layer of another adhesive film was faced with the aforementioned exposed curable resin composition layer and laminated under the same conditions as above. By repeating lamination in this way, the curable resin composition layer was gradually made thicker to finally afford a resin board of about 1.2 mm thickness. This resin board was placed in a metal mold (100 mm×100 mm×1 mm), subjected to pressurization vacuum press molding at 150° C. for 30 min, then 180° C. for 90 min, under a pressure of 50 MPa, and further postcured at 180° C. for 60 min to give a cured product layer resin board of 1 mm thickness. An evaluation sample of 80 mm length and 2 mm width was cut out from the obtained cured product layer resin board. The evaluation sample was measured for the relative dielectric constant and dielectric tangent using an HP8362B apparatus manufactured by Agilent Technologies according to the cavity resonance perturbation method at a measurement frequency of 5.8 GHz and a measurement temperature of 23° C.

[Measurement of Peel Strength]

The curable resin composition layer of the adhesive film with a copper foil was faced with a copper board and laminated with a vacuum laminator under the conditions of temperature 120° C., pressure 5 kgf/cm (4.9×10⁵ Pa), air pressure not more than 5 mmHg (6.7×10² Pa). The curable resin composition sandwiched between the copper foil and the copper board in this way was heated at 180° C. for 2 hr to give a sample for peel strength measurement.

A sample for peel strength measurement of plating was prepared as follows.

First, the curable resin composition layer of an adhesive film with a copper foil was faced with a copper board and laminated with a vacuum laminator under the conditions of temperature 120° C., pressure 5 kgf/cm (4.9×10⁵ Pa), air pressure not more than 5 mmHg (6.7×10² Pa). The curable resin composition sandwiched between the copper foil and the copper board in this way was heated (cured) at 180° C. for 30 min, and the copper foil was removed by dissolution. The surface of the exposed cured product layer was roughened with an aqueous alkaline oxidant solution, and a conductive layer was formed by plating to give a measurement sample. The peel strength of the sample was evaluated in accordance with the Japanese Industrial Standards (JIS) C6481.

[Evaluation of Heat Resistance and Moisture Resistance]

The measurement samples for relative dielectric constant and dielectric tangent were evaluated for variations in the relative dielectric constant and dielectric tangent relative to the initial values thereof when stood with the lapse of time under the high temperature or high humidity conditions of the following conditions 1) or 2). The relative dielectric constant (∈r) and dielectric tangent (tan δ) were measured using an HP8362B apparatus manufactured by Agilent Technologies and according to the cavity resonance perturbation method at measurement frequency 5.8 GHz and measurement temperature 23° C.

conditions 1) 125° C.: 250 hr

conditions 2) 85° C./85% RH: 250 hr

The compositions of the curable resin compositions of Examples 1-3 and Comparative Example 1 are shown in Table 1, and the results of each test are shown in Table 2.

In addition, the compositions of the curable resin compositions of Examples 4-6 and Comparative Example 2 are shown in Table 3, and the results of each test are shown in Table 4.

TABLE 1

| | | | | Comp. |
|---|---|---|---|---|
| Component added | Ex. 1 | Ex. 2 | Ex. 3 | Ex. 1 |
| polyvinylbenzyl compound (V5000X) | 37 | 33.5 | 37 | |
| polyvinyl benzyl ether compound | | | | 40 |
| (V1100X) | | | | |
| trifunctional acrylate (R-790) | | 2.7 | | |
| modified SEBS (M1913) | 6 | 5.5 | | |
| modified SBBS (N503M) | | | 6 | |
| non-modified SEBS (S8104) | | | | 6 |
| Acrylsilane-treated SrTiO₃ powder | | | 70 | 70 |
| Styrylsilane-treated SrTiO₃ powder | 70 | 70 | | |
| toluene | 18 | 18 | 18 | 18 |

TABLE 2

| | | | | | | Comp. |
|---|---|---|---|---|---|---|
| | | | Ex. 1 | Ex. 2 | Ex. 3 | Ex. 1 |
| peel | copper foil | | 0.54 | 0.57 | 0.56 | 0.38 |
| strength | (Rz = 2.3 μm) | | | | | |
| (kgf/cm) | copper plating | | 0.62 | 0.63 | 0.65 | 0.41 |
| dielectric | initial | εr | 10.19 | 10.22 | 10.48 | 10.28 |
| property | dielectric | tanδ | 0.00308 | 0.00315 | 0.00357 | 0.00532 |
| | property | | | | | |
| | heat | εr | 10.23 | 10.24 | 10.53 | 10.48 |
| | resistance | tanδ | 0.00300 | 0.00311 | 0.00362 | 0.00654 |
| | (250 h) | | | | | |
| | moisture | εr | 10.38 | 10.37 | 10.65 | 10.46 |
| | resistance | tanδ | 0.00612 | 0.00626 | 0.00678 | 0.00784 |
| | (250 h) | | | | | |
| | εr | heat | 0.4 | 0.2 | 0.5 | 1.0 |
| | variation | resistance | | | | |
| | rate (%) | moisture | 1.8 | 1.5 | 1.6 | 1.8 |
| | | resistance | | | | |

TABLE 3

| | | | | Comp. |
|---|---|---|---|---|
| Component added | Ex. 4 | Ex. 5 | Ex. 6 | Ex. 2 |
| polyvinylbenzyl compound (V5000X) | 37 | 33.5 | 37 | |
| polyvinyl benzyl ether compound | | | | 40 |
| (V1100X) | | | | |
| trifunctional acrylate (R-790) | | 2.7 | | |
| modified SEBS (M1913) | 6 | 5.5 | | |
| modified SBBS (N503M) | | | 6 | |
| non-modified SEBS (S8104) | | | | 6 |
| toluene | 18 | 18 | 18 | 18 |

TABLE 4

| | | | | | | Comp. |
|---|---|---|---|---|---|---|
| | | | Ex. 4 | Ex. 5 | Ex. 6 | Ex. 2 |
| peel | copper foil | | 0.60 | 0.59 | 0.62 | 0.42 |
| strength | (Rz = 2.3 μm) | | | | | |
| (kgf/cm) | copper plating | | 0.66 | 0.63 | 0.67 | 0.46 |
| dielectric | initial | εr | 2.51 | 2.53 | 2.53 | 2.53 |
| property | dielectric | tanδ | 0.00276 | 0.00302 | 0.00292 | 0.00477 |
| | property | | | | | |
| | heat | εr | 2.51 | 2.54 | 2.55 | 2.56 |
| | resistance | tanδ | 0.00232 | 0.00285 | 0.00332 | 0.00594 |
| | (250 h) | | | | | |
| | moisture | εr | 2.55 | 2.56 | 2.57 | 2.57 |
| | resistance | tanδ | 0.00392 | 0.00412 | 0.00432 | 0.00653 |
| | (250 h) | | | | | |
| | εr | heat | 0 | 0.4 | 0.8 | 1.2 |
| | variation | resistance | | | | |
| | rate (%) | moisture | 1.6 | 1.1 | 1.6 | 1.6 |
| | | resistance | | | | |

It is appreciated from Tables 2 and 4 that, using the curable resin composition of the present invention, a cured product layer that strongly adheres to a copper foil or copper plating can be obtained without impairing the superior properties of a curable polyvinylbenzyl compound.

This application is based on a patent application Nos. 2004-346792 and 2004-346793 filed in Japan on Nov. 30, 2004, the contents of which are incorporated in full herein by this reference.

1. A curable resin composition comprising curable polyvinylbenzyl compound (A), and modified styrene elastomer (B) having one or more kinds of not less than one functional group selected from the group consisting of a hydroxyl group, a carboxyl group, an amino group and an acid anhydride group.

2. The curable resin composition of claim 1, wherein compound (A) is a compound represented by the following formula (1): 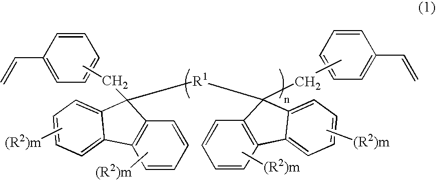
wherein
R¹ is a divalent organic group having 2 to 20 carbon atoms, each R² is the same or different and one group selected from the group consisting of a hydrogen atom, a halogen atom, an alkyl group, an alkoxy group and a thioalkoxy group, or two or more R² form a ring in combination, m is an integer of 0 to 4, and n is an integer of 0 to 20.

3. The curable resin composition of claim 1, wherein elastomer (B) has one or more kinds of functional groups selected from the group consisting of a carboxyl group and an acid anhydride group.

4. The curable resin composition of claim 1, wherein the mass ratio of compound (A) to elastomer (B) is 50/50-97/3.

5. The curable resin composition of claim 1, further comprising dielectric powder (C).

6. The curable resin composition of claim 5, wherein dielectric powder (C) is one or more kinds of powder selected from the group consisting of barium titanate, strontium titanate, calcium titanate, magnesium titanate, bismuth titanate, zirconium titanate, zinc titanate and titanium dioxide.

7. The curable resin composition of claim 5, wherein dielectric powder (C) is surface-treated with a surface treating agent.

8. The curable resin composition of claim 7, wherein the surface treating agent is one or more kinds of silane surface treating agents selected from the group consisting of styrylsilane, vinylsilane, acrylsilane and methacrylsilane.

9. The curable resin composition of claim 5, wherein the content of dielectric powder (C) in the curable resin composition is 50 to 95 mass %.

10. An adhesive film comprising a supporting film and a layer made of the curable resin composition of claim 1, which is formed on the supporting film.

11. An adhesive film with a copper foil, comprising a copper foil and a layer made of the curable resin composition of claim 1, which is formed on the copper foil.

12. A prepreg obtained by impregnating a sheet fiber substrate with the curable resin composition of claim 1.

13. A method of producing a multi-layer printed circuit board, which comprises:
(1) laminating the adhesive film of claim 10 on a circuit substrate,
(2) removing or not removing the supporting film,
(3) heat-curing the curable resin composition,
(4) separating the supporting film when it is present,
(5) roughening the surface of the cured product layer with an aqueous alkaline oxidant solution,
(6) forming a conductive layer on the roughened surface of the cured product layer by plating, and
(7) forming a circuit on the conductive layer.

14. A method of producing a multi-layer printed circuit board, which comprises:
(1) laminating the adhesive film with a copper foil of claim 11 on a circuit substrate,
(2) heat-curing the curable resin composition,
(3) removing the copper foil by dissolution,
(4) roughening the surface of the cured product layer with an aqueous alkaline oxidant solution,
(5) forming a conductive layer on the roughened surface of the cured product layer by plating, and
(6) forming a circuit on the conductive layer.

15. A method of producing a multi-layer printed circuit board, which comprises:
(1) laminating the adhesive film with a copper foil of claim 11 on a circuit substrate,
(2) heat-curing the curable resin composition, and
(3) forming a circuit on the copper foil layer.

16. A method of producing a multi-layer printed circuit board, which comprises:
(1) laminating the prepreg of claim 12 on a circuit substrate,
(2) heat-curing the curable resin composition,
(3) roughening the surface of the cured product layer with an aqueous alkaline oxidant solution,
(4) forming a conductive layer on the roughened surface of the cured product layer by plating, and
(5) forming a circuit on the conductive layer.

17. A multi-layer printed circuit board comprising an insulating layer and a conductive layer, wherein at least a part of the insulating layer is formed by curing the curable resin composition of claim 1.

18. An electronic component comprising an insulating layer, wherein at least a part of the insulating layer is formed by curing the curable resin composition of claim 1.

19. A multi-layer printed circuit board comprising an insulating layer and a conductive layer, wherein at least a part of the insulating layer is formed by curing the prepreg of claim 12.

20. An electronic component comprising an insulating layer, wherein at least a part of the insulating layer is formed by curing the prepreg of claim 12.

21. An adhesive film comprising a supporting film and a layer made of the curable resin composition of claim 5, which is formed on the supporting film.

22. An adhesive film with a copper foil, comprising a copper foil and a layer made of the curable resin composition of claim 5, which is formed on the copper foil.

23. A prepreg obtained by impregnating a sheet fiber substrate with the curable resin composition of claim 5.

24. A multi-layer printed circuit board comprising an insulating layer and a conductive layer, wherein at least a part of the insulating layer is formed by curing the prepreg of claim 23.

25. An electronic component comprising an insulating layer, wherein at least a part of the insulating layer is formed by curing the prepreg of claim 23.

26. A multi-layer printed circuit board comprising an insulating layer and a conductive layer, wherein at least a part of the insulating layer is formed by curing the curable resin composition of claim 5.

27. An electronic component comprising an insulating layer, wherein at least a part of the insulating layer is formed by curing the curable resin composition of claim 5.
